(19) United States
(12) Patent Application Publication
(10) Pub. No.: US 2003/0137542 A1
(43) Pub. Date: Jul. 24, 2003

(54) User interface for reviewing and controlling use of data objects

(75) Inventors: John Zimmerman, Ossining, NY (US); Jacquelyn Annette Martino, Cold Spring, NY (US); Guy Roberts, Eindhoven (NL)

Correspondence Address: PHILIPS ELECTRONICS NORTH AMERICAN CORP, 580 WHITE PLAINS RD, TARRYTOWN, NY, 10591, US

(73) Assignee: Koninklijke Philips Electronics N.V.

(21) Appl. No.: 10/055,338

(22) Filed: Jan. 22, 2002

(51) Int. Cl. G09G 5/00

(52) U.S. Cl. 345/764

(57) ABSTRACT

A user interface for controlling tasks relating to media or other searchable data objects simultaneously indicates a current search criteria set, results set, and task set. The task set indicates a subset of the results on which a currently selected task is to be performed. For example, a task could be recording music on a CD, recording video on a DVD, storing video on a tape, playing music, emailing a media file such as a video or musical recording, printing or erasing a file, etc. The search criteria, results, and task sets may be simultaneously displayed or a placeholder displayed that may be expanded upon activation of one of them. At all times, at least some indication of all three is shown.

### FIELD OF THE INVENTION

The invention relates to user interfaces for conveniently reviewing media content such as broadcast events and stored music files such as electronic media guides, electronic program guides, and search engines, etc. and particularly to those of such interfaces that permit the control of tasks relating to selected media content.

### BACKGROUND

User interfaces for doing tasks with media data, such as broadcast media or recording titles, are used in various contexts and may involve filtering selections from a large body of data objects. The large quantity of such media data, for example the huge number of programs simultaneously available with satellite and cable TV, presents new challenges for the design of user interfaces for searching and browsing to review and select information.

There is an on-going need for improvements in the design of the user interfaces used to search, display, and route selected media choices, documents, etc. Many user interfaces merely present the user with a query window and then display a simple text list. Such devices are employed by search engines, EPGs, text search tools such as Folio®, etc. But these are tedious to work with because of the awkwardness of having to navigate multiple views defining the search problem, the results, and the disposition of search results (e.g., saving, printing, recording, playing, etc.) This situation is particularly tedious when the disposition involves multiple possible tasks to be performed with selected elements of the search results set.

### SUMMARY OF THE INVENTION

A search engine display process, which may be run on a general-purpose computer, electronic program guide (EPG), software or hardware media player, embedded system, etc. displays controls for searching, reviewing results, and tasks to be preformed with search results on a single display. According to an embodiment, the current settings are also displayed along with the controls for modifying their respective settings.

In an embodiment, content filters, results, and task lists, are all shown simultaneously along with controls for their modification on a single display. The content filters may include, for example, controls showing and permitting the selection of search criteria, user profiles with embedded selection criteria, a data source (universe) to be searched, etc. The results list may be a linear, preferably hierarchical, display showing one or more hierarchical levels. The results list is preferably in the form of the hierarchical structure with attending controls described in a patent application filed concurrently with the present application, entitled “Method and System for Displaying Search Results,” the contents of which are hereby incorporated by reference as if fully set forth in their entirety herein. The task list shows the content that is to be subjected to some selected action. Results from the results list can be transferred to the task list from the current search results. For example, the task list may show things to be recorded, stored, printed, displayed, played now or at a time and/or date in the future, transferred to another location, etc. Controls for modifying the contents and type of task indicated by the task list are preferably shown as well.

The invention will be described in connection with certain preferred embodiments, with reference to the following illustrative figures so that it may be more fully understood. With reference to the figures, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

### BRIEF DESCRIPTION OF THE DRAWINGS

FIG. 1 shows a diagram indicating a process for implementing the invention according to an embodiment thereof.

FIG. 2 shows an example of a hardware environment for implementing an embodiment of the invention.

FIGS. 3-8 illustrate a set of displays and controls that show, and permit modification of, content filters, search results, and task list in successive stages of expansion.

### DETAILED DESCRIPTION OF THE PREFERRED EMBODIMENTS

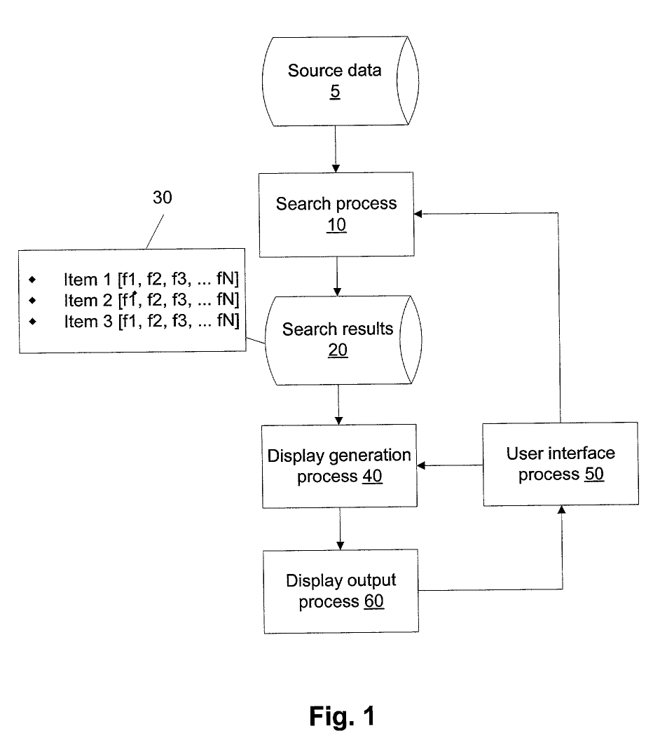

Referring to FIG. 1, a process for searching and displaying search results is shown for illustrating one possible functional mechanism for implementing the invention. Source data 5, which may reside on a remote server or peer, a local data store, or other data store or source is filtered by a search process 10 controlled by a user interface process 50 in a manner in accord with any current or future mechanism for searching and filtering data. The search process produces a filtered set of search results 20. A display generation process 40 then accesses the search results 20 and formats it for output by a display output process 60. The display generation process 40 is also under control of the user interface process 50.

Note that the user interface process may include soft controls such as display graphic controls like buttons, radio buttons, etc. in combination with or as alternatives to hardware controls such as a television-type remote control. The process may display criteria and feature value sets for use in searching and may display the search results generated by the display output process 60. The configuration illustrated by FIG. 1 is only one of many possible as will be appreciated by persons of skill in the relevant fields of art in light of the current specification.

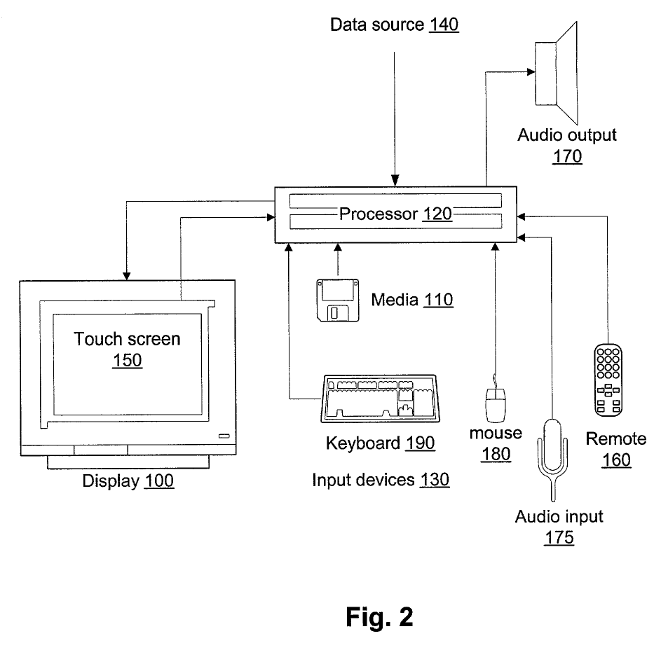

Referring now also to FIG. 2, a hardware environment that may be employed to generate the processes shown in FIG. 1 includes a processor 120 which may be an embedded system, a control processor including internal memory and storage, a general purpose computer, etc. The processor 120 receives data from a data source 140, which may provide the source data 5 illustrated in FIG. 1, from a remote server or local data store or any other source (not shown) Various input devices 130 such as a keyboard, touch screen 150, mouse 180, audio input (e.g., microphone) 175, handheld remote control 160, etc. may be used to provide input to the user interface process 50 of FIG. 1. Search results and controls may be displayed on a monitor display 100 which may be a television LCD screen or other display. Results or controls may be provided in part or in toto by an audio interface whose output is a speaker 170 according to various techniques for such interfaces, such as audio prompting and speech input. User profiles or predefined queries stored on removable media 110 may be entered into the processor 120 according to any suitable means or media type.

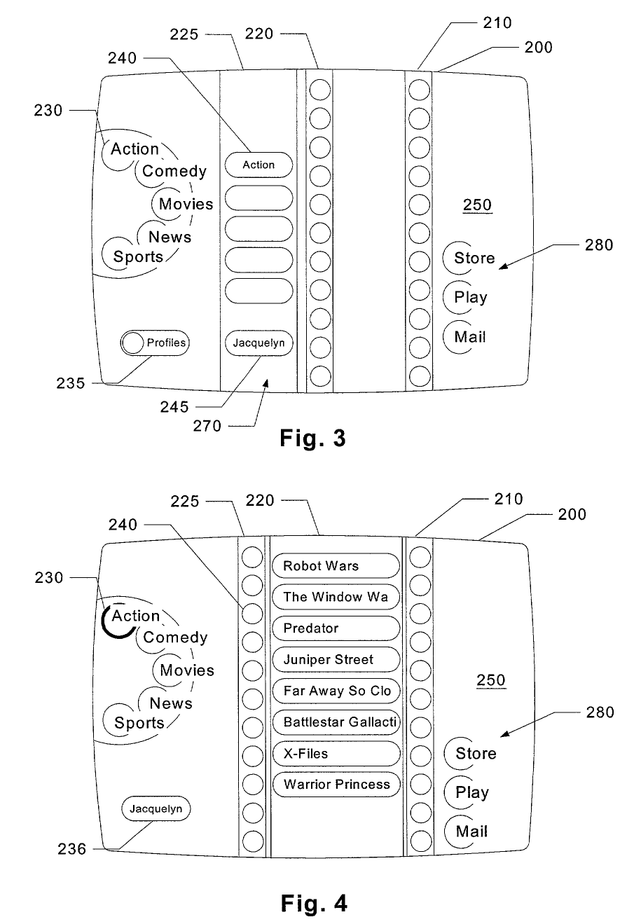

Referring now to FIG. 3, a display area 200 contains respective regions for displaying selection criteria 225, for selection results 220, and for task items 210. The latter two are shown in a hidden or “closed” state whilst the selection criteria section 225 is shown in an expanded or “open” state. The controls may be actuated in any suitable manner, for example by selecting and activating a control switch (such as on a remote control) or by dragging and dropping with a pointer such as a mouse. Here, the open selection criteria section 225 indicates that two selection criteria are currently active: a user profile for Jacquelyn and a favored genre, action. The profile may be any type of suitable profile, such as one for a particular user and defining many types of preferences thereby making it unnecessary that they be specified explicitly each time content is being reviewed. Any kind of query-generation process could also be used, for example, one or more of the controls shown in FIG. 3 could be a text box for entering key words, or the controls could specify different kinds of filters. For example, archetypal users such as “sports fan,” “hopeless romantic,” or “techno-geek” could be provided and selected. Field-specific query templates could be provided as well such as a title text box, date or date-range control, rating selector, etc.

In the example of FIG. 3, a source icon such as the action icon 230 may be selected and dragged into the selection criteria section 225. The same is done for selecting the user profile.

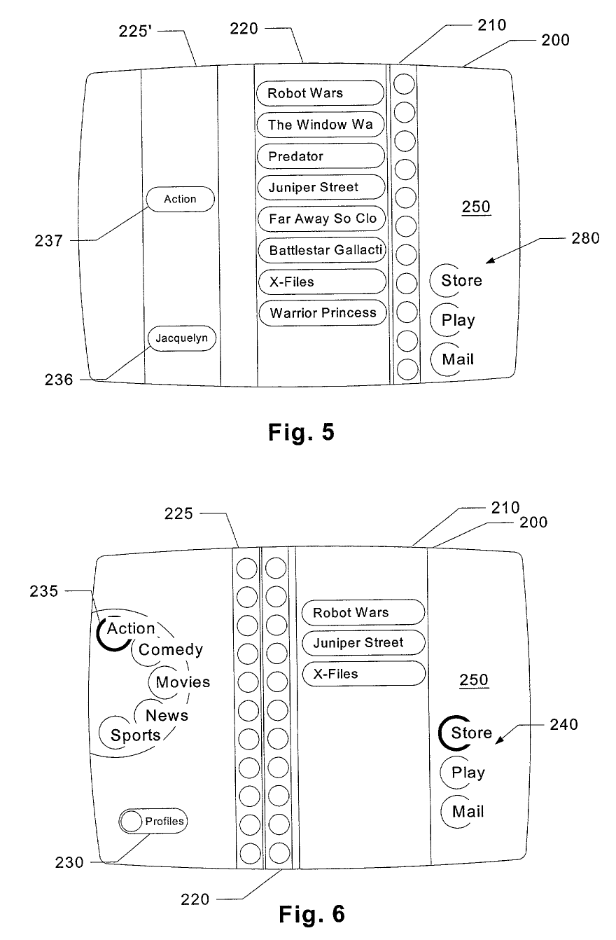

The filter criteria are defined or selected, a search initiated, and the results displayed in region 220 which then opens as shown in FIG. 4. Note that in an alternative embodiment, the search criteria or a subset may continue to be shown. For example, as illustrated in FIG. 4, the action genre is indicated by highlighting in the control at 230 and the selected profile is shown at 236. An alternative way to indicate the current filter criteria is to display the current selections and hide the source icons 230 (FIG. 4) as shown in FIG. 5. In this case, the selection criteria are not hidden and the selection criteria section 225 is not closed.

Note that in both FIGS. 4 and 5, the search criteria and results are shown in the same display. Also, the controls may be made instantly accessible to modify the search criteria by the user. This may be done by passing a pointer over the closed section 225 or the open section 225′. In the embodiment of FIG. 4, this would cause the selection criteria section 225 to open and in the embodiment of Fig. FIG. 5, this action would cause the source icons to be displayed. The result in either case would be a reversion to the format of FIG. 3.

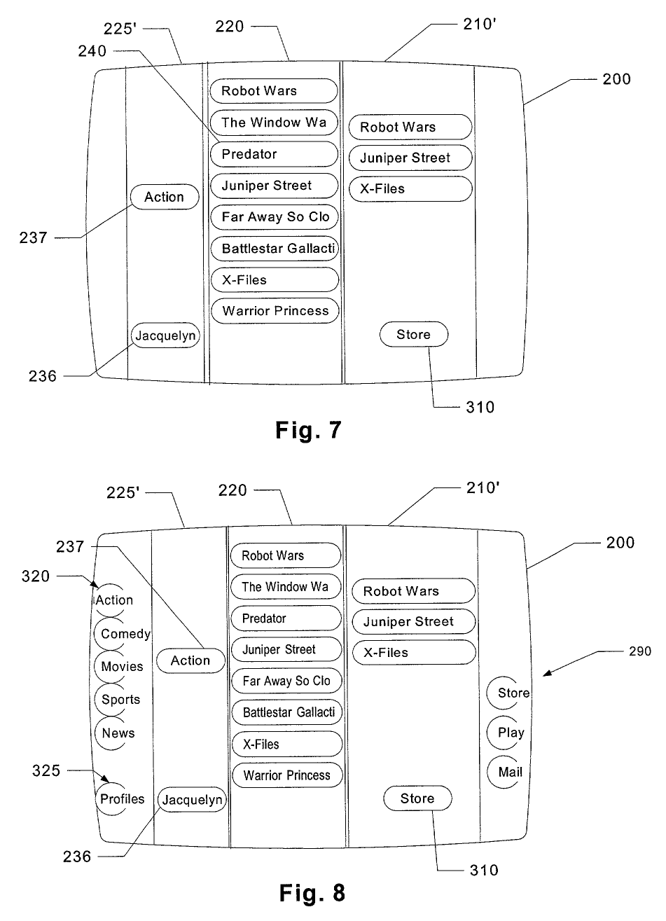

Referring now to FIG. 6, a task list 210 is displayed. The task or tasks to which the task list 210 refers is/are identified by task controls 240. The tasks may be any type permitted the user interface. Examples include recording music on a CD, recording video on a DVD, storing video on a tape, playing music, emailing a media file such as a video or musical recording, printing or erasing a file, etc. In the example shown, the items in the task list 210 are to be stored as indicated by the highlighting of the controls 240. In the example of FIG. 6, the search criteria 225 and results list 220 are shown in a closed position. In an alternative embodiment, only one of which is shown in FIG. 7, either or both could be shown in an open position. Referring to FIG. 7, the results 220, search criteria 225 and task 210 lists are shown in an open position and the source controls 230 and 235 for the search criteria list 225 removed. However, the current selections for the controls are indicated in the respective lists. In an alternative embodiment, the source controls are ghosted instead of hidden.

The task controls, in an embodiment of the invention, may also filter content in the search results list 220, since some content may be susceptible to a given action while other content may not. For example, if the user has a subscription or license to record certain content but not others, the result list would only display content that could be recorded if the record control were currently active.

The effect of the foregoing embodiments is that search criteria and results are shown alongside tasks in the same display. In an embodiment, only the search criteria list 225 or the task list 210 is active at a time with the results list 220 always showing a current results set. When the search criteria list 225 is active, its source controls 230 and 235 are either displayed or unghosted (made easier to see or otherwise highlighted). When the task list 210 is active, its source controls 240 are either displayed or unghosted. Also, the arrangement of the different portions of the display 225, 220, 210 is preferably such as to follow a natural progression for the embodiment. So, if the first step is selecting content filters in a country in which left-to-right is the natural direction to follow, then content filter section 225 would be at the left and the results section to the right of it. If the task controls filter content, then the task controls may be placed all the way to the left in such a country so that the content filters may all be established as a first step.

Referring now to FIG. 8, in a further embodiment, all controls and lists may be active at all times. The search criteria source controls 320 and 325 are shown and the task list source controls 290 are shown and available continuously. The results list always shows the current result set. In this embodiment, no controls need be ghosted or hidden. In the example shown, the currently-selected genre and profile parameters 236 and 237 are shown in the search criteria list 225′, but it is possible to display them in a different manner, for example by highlighting of the source controls (not shown) rather than placing them in the list area.

It will be evident to those skilled in the art that the invention is not limited to the details of the foregoing illustrative embodiments, and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

For example, although the controls, e.g., 670 and 775 are shown as handles, they could be replaced by tiles or other symbols that are actuated and the hierarchy level indicated by some other display parameter such as an icon or the color of the list item.

We claim:

1. A method for generating a media control user interface, comprising the steps of:
displaying controls indicating current search criteria in a display area;
simultaneously displaying on said display area results of a search defined by said search criteria;
simultaneously displaying at least one current task to be performed with respect to selected ones of said results and indicating said selected ones;
simultaneously permitting access to controls to modify at least one of said search criteria, said at least one current task, and said selected ones.

2. A method as in claim 1, further comprising the step of simultaneously displaying controls to modify said at least one of said search criteria, said at least one current task, and said selected ones.

3. A method for generating a media control user interface, comprising the steps of:
displaying an indication of search controls indicating current search criteria in a display area;
simultaneously displaying on said display area an indication of results of a search defined by said search criteria;
simultaneously displaying an indication of task controls and an indication of at least one current task to be performed with respect to selected ones of said results and an indication of said selected ones;
permitting a user to access said search controls and said task controls;
selectively displaying at least one of said results, currently selected search criteria, and said at least one current task responsively to commands from a user.

4. A method as in claim 3, further comprising, immediately updating said results list responsively to current settings of said search controls.

5. A method as in claim 3, further comprising, immediately updating said indication of at least one current task responsively to modification of said task controls.

6. A method as in claim 5, further comprising, immediately updating said results list responsively to current settings of said search controls.

7. A user interface for controlling tasks relating to media or other searchable data objects, comprising:
a display generator configured to simultaneously indicate a current search criteria set, results set, and task set;
said task set indicating a subset of the results on which a currently selected task is to be performed;
each of said search criteria, results, and task sets being, or a place-holder therefor, being simultaneously displayed;
said place-holder being activateable responsive to control commands.

8. A user interface, wherein said task set provides at least one of recording music on a CD, recording video on a DVD, storing video on a tape, playing music, emailing a media file such as a video or musical recording, printing and erasing a file.
